(19) United States
(12) Patent Application Publication
(10) Pub. No.: US 2019/0092380 A1
(43) Pub. Date: Mar. 28, 2019

(54) STEERING TORQUE CONTROL

(71) Applicant: Ford Global Technologies, LLC, Dearborn, MI (US)

(72) Inventors: Domenic Miccinilli, Royal Oak, MI (US); Mohamad Wajih Issam Farhat, Dearborn, MI (US); Jens Christiansen, Plymouth, MI (US); Nathaniel Abram Rolfes, Detroit, MI (US)

(73) Assignee: Ford Global Technologies, LLC, Dearborn, MI (US)

(21) Appl. No.: 15/713,213

(22) Filed: Sep. 22, 2017

(51) Int. Cl. B62D 5/04; B62D 15/02

(52) U.S. Cl. CPC B62D 5/0463; G05D 1/0061; B62D 15/025; B62D 15/0225

(57) ABSTRACT

A system includes a computer that is programmed to determine a vehicle steering wheel angle based on a vehicle steering torque and a vehicle pinion angle and to determine a compensated steering torque by applying a high-pass filter to the determined vehicle steering wheel angle. The computer is programmed to actuate a vehicle component based on the determined compensated steering torque. A parameter of the high-pass filter is based on a vehicle speed.

### BACKGROUND

One or more computers can be programmed to control vehicle operations, e.g., as a vehicle travels on a road. For example, a computer may control vehicle operation in an autonomous mode, e.g., by controlling the vehicle acceleration, braking, and steering. A vehicle user may turn a vehicle steering wheel to steer the vehicle. However, upon receiving user input to change a vehicle steering angle, i.e., a user turns a steering wheel, problems arise in determining an amount of torque to apply to a vehicle steering system and/or in determining whether to apply torque at all.

### BRIEF DESCRIPTION OF THE DRAWINGS

FIG. 1 is a diagram of an example vehicle including an example steering system.

FIG. 2 is a block diagram of the steering system of FIG. 1.

FIG. 3 is a block diagram for determining compensated steering torque.

FIG. 4 is a graph showing a filter cutoff frequency versus a vehicle speed.

FIGS. 5A-5B are a flowchart of an exemplary process for controlling vehicle operation.

### DETAILED DESCRIPTION

### Introduction

Disclosed herein is a system including a computer that is programmed to determine a vehicle steering wheel angle based on a vehicle steering torque and a vehicle pinion angle, and to determine a compensated steering torque by applying a high-pass filter to the determined vehicle steering wheel angle, wherein a parameter of the high-pass filter is based on a vehicle speed. The computer is programmed to actuate a vehicle component based on the determined compensated steering torque.

The computer may be programmed to determine the compensated steering torque based on the input torque.

The computer may be programmed to receive the vehicle steering pinion angle from a pinion angle sensor that is engaged to a lower end of the vehicle pinion.

The system may further include the vehicle pinion including a lower end of the vehicle pinion that is mechanically coupled to a vehicle steering rack and an upper end of the vehicle pinion that is mechanically coupled, via a torsion bar, to the vehicle steering wheel.

The computer may be further programmed to determine a cutoff frequency of the high-pass filter based on vehicle speed.

The computer may be further programmed to determine the cutoff frequency of the high-pass filter by selecting, based on the vehicle speed, the cutoff frequency from a plurality of predetermined cutoff frequencies.

The computer may be further programmed to select a mode of operation based on the determined compensated steering torque and a predetermined torque threshold and actuate the vehicle component based on the selected vehicle mode of operation.

The selected mode of operation may be one of a vehicle autonomous mode and a vehicle non-autonomous mode of operation.

The computer may be further programmed to actuate a non-autonomous mode of operation upon determining that the compensated steering torque exceeds the predetermined torque threshold.

The computer may be further programmed to determine a filtered compensated steering torque by applying a low-pass filter to the determined compensated steering torque, and actuate the vehicle component based at least in part on the determined filtered compensated steering torque.

The computer may be further programmed to determine a torque offset based on a steering wheel inertia and an output of the high-pass filter.

The computer may be further programmed to receive the input torque from a torque sensor coupled to a lower end of a torsion bar.

The computer may be further programmed to determine a torsion bar differential angle based on the input torque, and to determine a steering wheel angle based on the torsion bar differential angle and the vehicle steering pinion angle.

Further disclosed herein is a method including determining a vehicle steering wheel angle based on a vehicle steering torque and a vehicle pinion angle, determining a compensated steering torque by applying a high-pass filter to the determined vehicle steering wheel angle, wherein a parameter of the high-pass filter is based on a vehicle speed, and actuating a vehicle component based on the determined compensated steering torque.

The method may further include determining the compensated steering torque based on the input torque.

The method may further include receiving the vehicle steering pinion angle from a pinion angle sensor that is engaged to a lower end of the vehicle pinion.

The method may further include actuating a non-autonomous mode of vehicle operation upon determining that the compensated steering torque exceeds the predetermined torque threshold.

The method may further include determining a filtered compensated steering torque by applying a low-pass filter to the determined compensated steering torque, and actuating the vehicle component based at least in part on the determined filtered compensated steering torque.

The method may further include determining a torque offset based on a steering wheel inertia and an output of the high-pass filter.

The method may further include determining a torsion bar differential angle based on the input torque, and determining a steering wheel angle based on the torsion bar differential angle and the vehicle steering pinion angle.

Further disclosed is a computing device programmed to execute the any of the above method steps. Yet further disclosed is an aerial drone comprising the computing device. Yet further disclosed is a vehicle comprising the computing device.

Yet further disclosed is a computer program product comprising a computer readable medium storing instructions executable by a computer processor, to execute the any of the above method steps.

### Exemplary System Elements

A computer of a vehicle such as an autonomous vehicle may control a vehicle steering operation. A user may apply torque to a vehicle steering wheel while the computer controls the vehicle steering operation. In such conditions, the computer may need to determine whether to actuate a vehicle steering actuator based on the user input (i.e., applied torque to the steering wheel). Thus, advantageously, the vehicle steering operation may be improved with regard to evaluating and acting on torque input to a steering wheel while the vehicle steering is autonomously operated.

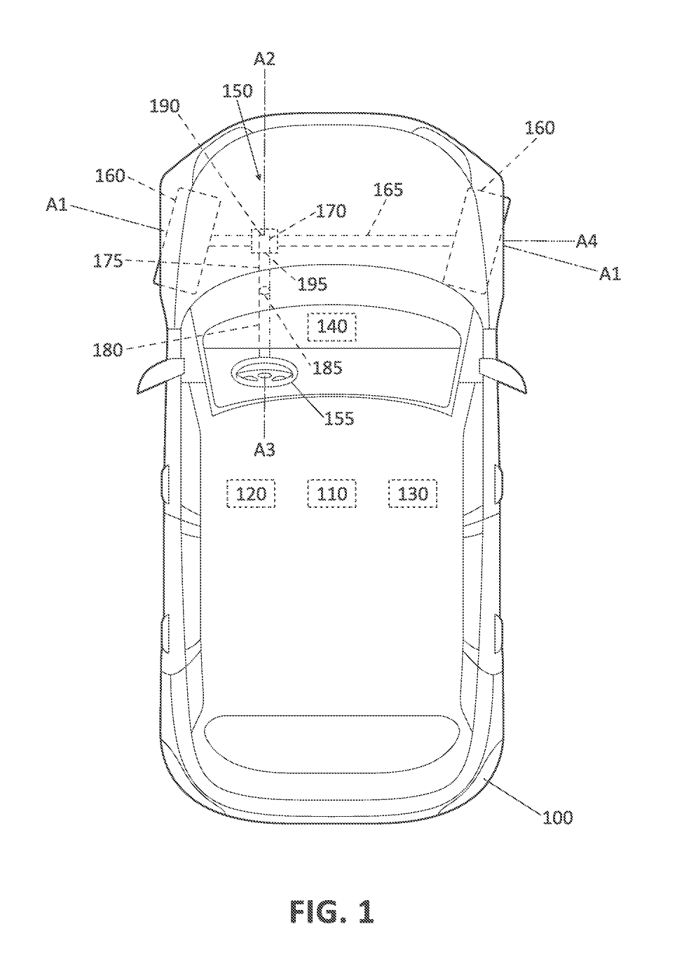

FIG. 1 illustrates a vehicle 100. The vehicle 100 may be powered in a variety of known ways, e.g., with an electric motor and/or internal combustion engine. The vehicle 100 may be a land vehicle such as a car, truck, etc. A vehicle 100 may include a computer 110, actuator(s) 120, sensor(s) 130, a human machine interface (HMI) 140, a steering system 150.

The computer 110 includes a processor and a memory such as are known. The memory includes one or more forms of computer-readable media, and stores instructions executable by the computer 110 for performing various operations, including as discussed herein.

The computer 110 may operate the respective vehicle 100 in an autonomous or a semi-autonomous mode. For purposes of this disclosure, an autonomous mode is defined as one in which each of vehicle 100 propulsion, braking, and steering are controlled by the computer 110; in a semi-autonomous mode the computer 110 controls one or two of vehicle 100 propulsion, braking, and steering.

The computer 110 may include programming to operate one or more of land vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via a vehicle 100 communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network that can include a bus in the vehicle such as a controller area network (CAN) or the like, and/or other wired and/or wireless mechanisms.

Via the vehicle 100 network, the computer 110 may transmit messages to various devices in the vehicle 100 and/or receive messages from the various devices, e.g., an actuator 120, a sensor 130, an HMI 140, etc. Alternatively or additionally, in cases where the computer 110 actually comprises multiple devices, the vehicle 100 communication network may be used for communications between devices represented as the computer 110 in this disclosure. Further, as mentioned below, various controllers and/or sensors may provide data to the computer 110 via the vehicle communication network.

The HMI(s) 140 may be configured to receive information from a user, such as a human operator, during operation of the vehicle 100. Moreover, an HMI 140 may be configured to present information to the user. As one example, an HMI 140 may include a touchscreen, buttons, knobs, keypads, microphone, and so on for receiving information from a user. Moreover, an HMI 140 may include various interfaces such as may be provided by a vehicle 100 manufacturer (e.g., the Ford SYNC® system), a smart phone, etc., for receiving information from a user and/or output information to the user.

The sensors 130 may include a variety of devices to provide data to the computer 110. For example, the sensors 130 may include Light Detection And Ranging (LIDAR) sensor(s) 130, camera sensors 130, radar sensors 130, etc. disposed in and/or on the vehicle 100 that provide relative locations, sizes, and shapes of other objects such as other vehicles. As another example, the vehicle 100 may include angle and/or torque sensors 130 that provide angle and/or torque data from sensors 130 connected to various components of the steering system 150.

The steering system 150 may include various conventional steering components, such as a steering wheel 155, wheel(s) 160, a rack 165, a pinion 170, a torsion bar 175, a steering column 180, and a mechanical joint 185 mechanically coupling the torsion bar 175 and the steering column 180. Further, the vehicle 100 pinion 170 may include a lower end 190 and an upper end 195. The lower end 190 may be mechanically coupled to a vehicle 100 steering rack 165 and the upper end 195 of the vehicle 100 pinion 170 may be mechanically coupled, via the torsion bar 175 and the steering column 180, to the vehicle 100 steering wheel 155.

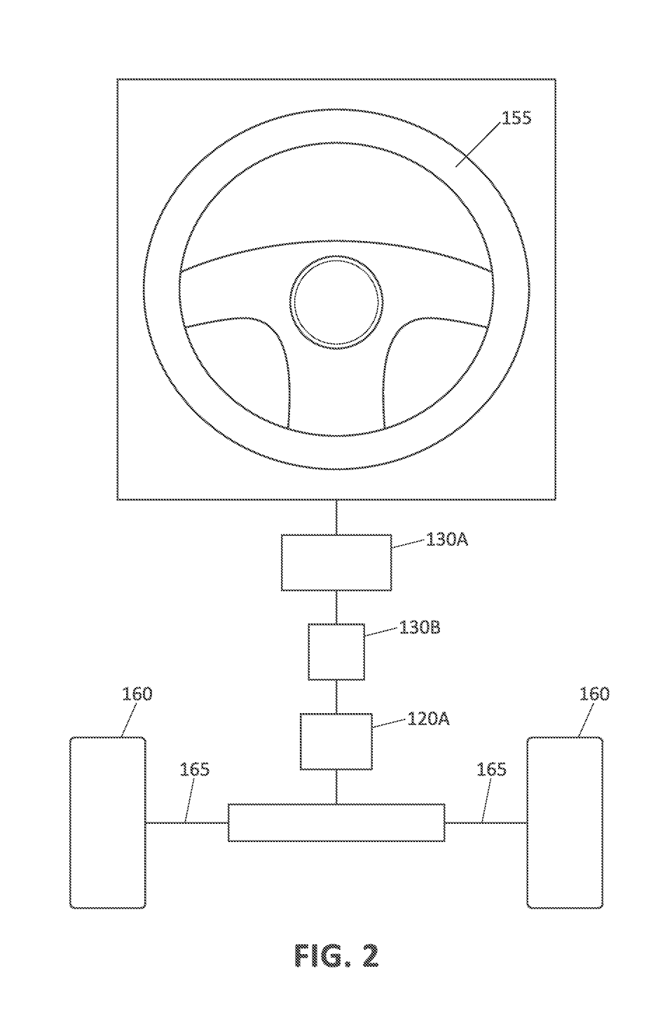

With reference to FIGS. 1 and 2, a vehicle 100 user may steer the vehicle 100 by applying torque to the vehicle 100 steering wheel 155. For example, the vehicle 100 user may rotate the steering wheel 155 about an axis A3 of the steering column 180 in a clockwise direction to steer the vehicle 100 to a rightward direction. The steering column 180 and the torsion bar 175 may be mechanically connected via the mechanical joint 185. Thus, a rotation of the steering column 180 may apply torque to the torsion bar 175 and cause the torsion bar 175 to twist about an axis A2. Twisting the torsion bar 175 may in turn apply torque to the pinion 170 to thereby rotate the pinion 170 to rotate about the axis A2. In the context of present disclosure, a twisting angle of the torsion bar 175 about the axis A2 is referred to as a differential angle. Thus, the steering torque measured about the axis A2 of the torsion bar 175 by the torque sensor 130B may be related to an amount (i.e., size or measurement) of the differential angle.

Further, the rack 165 and the pinion 170 may be mechanically connected. Thus, the torque applied to the pinion 170 may move the rack 165, e.g., to a right and/or left direction along an axis A4 of the rack 165. A movement of the rack 165 in a right or left direction in turn pivots axes A1 of the wheels 160 about an axis (not shown) that is perpendicular to a ground surface and passing through a center of the wheel 160, i.e., to use lay parlance, turns the wheels 160. This pivoting of the wheel 160 axes A1 may change a vehicle 100 steering direction. Additionally or alternatively, a steering 100 actuator 120A may apply torque to the pinion 170 to steer the vehicle 100. For example, in a vehicle 100 autonomous mode, the computer 110 may be programmed to actuate a vehicle 100 actuator 120A to steer the vehicle 100.

The computer 110 may be programmed to receive the pinion 170 angle from a sensor 130A that is mechanically coupled to the vehicle 100 pinion 170. The pinion 170 angle refers to an angle of rotation of the pinion 170 about the pinion 170 axis A2. In one example, the pinion 170 angle may include negative and positive amounts. For example, the pinion 170 angle may be 0 (zero) degrees while steering the vehicle 100 in a forward direction. The pinion 170 angle may have a positive or negative amount when the wheel 160 are directed to a right or left direction. In one example, the angle sensor 130A may be an optical, magnetic, etc. sensor mechanically coupled to the lower end 190 of the pinion 170.

The computer 110 may be programmed to receive torque data (e.g., an amount of torque currently being applied) from a sensor 130B coupled to the vehicle 100 pinion 170. In one example, the torque sensor 130B may be coupled to the lower end 190 of the pinion 170, e.g., included in a housing of the angle sensor 130A. In another example, the torque sensor 130B may be coupled to the upper end 195 of the pinion 170, the mechanical joint 185, etc. The torque data received from the sensor(s) 130 relating to the pinion 170 is herein referred to as the vehicle steering torque. The torque sensor 130B may be a transducer that converts a torsional mechanical input into an electrical output signal.

As discussed above, the torsion bar 175 may twist upon rotating the steering wheel 155 causing the differential angle. The computer 110 may be programmed to determine the differential angle of the torsion bar 175 based on the received steering torque from, e.g., the vehicle 100 torque sensor 130B.

The computer 110 may operate the vehicle 100 in an autonomous mode by actuating the vehicle 100 actuators 120 such as a steering actuator 120A based at least in part on data received from the vehicle 100 sensor 130. While the computer 110 operates the vehicle 100 steering in an autonomous mode, a vehicle 100 user may intend to intervene in a vehicle 100 steering operation, e.g., by applying torque to the vehicle 100 steering wheel 155. The computer 110 can be programmed to determine a vehicle 100 steering wheel 155 angle based on a vehicle steering torque and a vehicle 100 pinion 170 angle, determine a compensated steering torque by applying a high-pass filter to the determined vehicle 100 steering wheel 155 angle, and actuate a vehicle 100 component based on the determined compensated steering torque. At least one parameter of the high-pass filter may be based on a vehicle 100 speed. For example, the computer 110 can be programmed to adjust high-pass filter parameters based on the vehicle 100 speed.

The computer 110 may be further programmed to select a mode of operation, e.g., an autonomous mode, non-autonomous mode of operation, and/or a semi-autonomous mode, based on the determined compensated steering torque and a predetermined torque threshold. The computer 110 may be further programmed to actuate the vehicle 100 component based on the selected vehicle 100 mode of operation. In one example, the computer 110 may be programmed to actuate a vehicle 100 non-autonomous mode, e.g., switching from the autonomous mode to the non-autonomous mode, upon determining that the determined compensated steering torque exceeds the predetermined torque threshold, e.g., 5 Newton Meters (NM). In another example, the computer 110 may be programmed to deactivate the autonomous mode upon determining that the determined compensated steering torque exceeds the predetermined torque threshold for at least a predetermined time threshold, e.g., 1 second. Thus, advantageously, the computer 110 may identify a vehicle 100 user intervention and actuate the vehicle 100 component upon determining that the user intervention has occurred. An intervention may include turning the steering wheel 155 by the vehicle 100 user in a direction different from a current direction of the vehicle 100 steering.

The computer 110 may be further programmed to receive the vehicle 100 steering pinion 170 angle from a pinion angle sensor 130 that is engaged to a lower end 190 of the vehicle 100 pinion 170. For example, an angle sensor 130 may be mounted to a housing of the pinion 170 and can measure the pinion 170 angle by measuring a rotation of the pinion 170 relative to a reference point on the housing. In one example, the pinion 170 may have one or more notches on its perimeter and the sensor 130 may determine the pinion 170 angle based on a a number of times a notch passes the sensor 130 while rotating the pinion 170 about the axis A2. The computer 110 may be further programmed to receive the input torque from a torque sensor 130 coupled to the upper end 195 of the pinion 170.

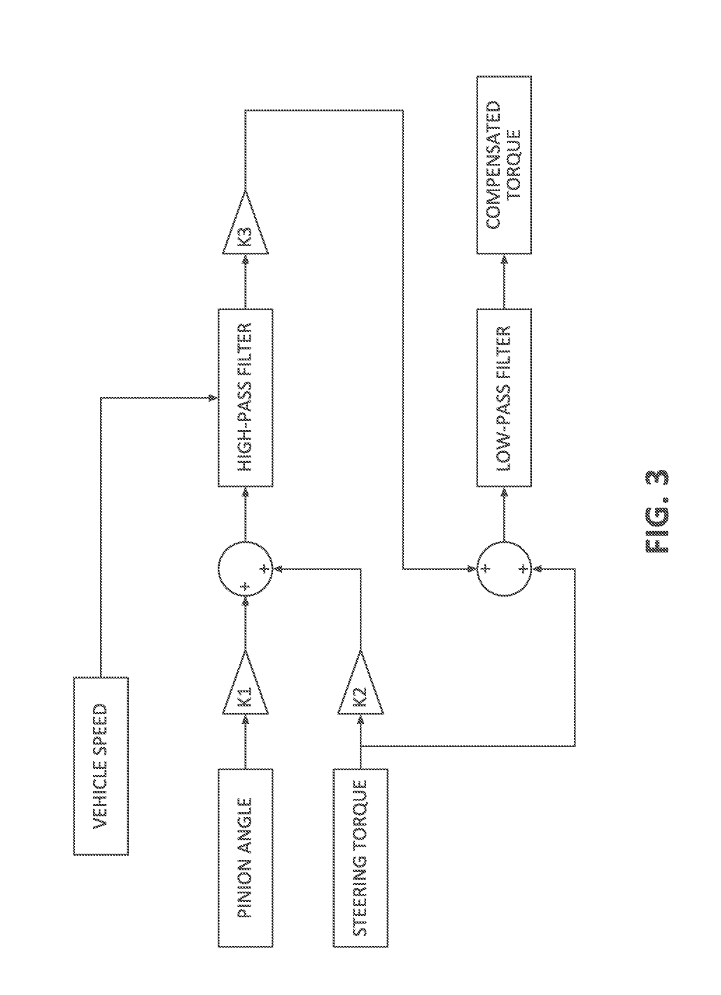

As shown in FIG. 3, the compensated steering torque may be determined based on the pinion 170 angle and the steering torque measured by the torque sensor 130. The determination of the compensated steering torque may include the operations of a high-pass and/or a low-pass filter, as discussed below. The filter parameters may be based at least in part on the vehicle 100 speed. Thus, the compensated steering torque may be based at least in part on the vehicle 100 speed. The compensated steering torque may be specified in Newton Meters (NM) or some other measure of force.

Band-pass filters such as discussed herein perform signal processing operations to remove unwanted frequency components from a signal and/or to enhance desired frequency components. Electronic circuitry may implement a band-pass filter and/or a computer such as the computer 110 may be programmed to perform a filtering operation, i.e., apply a filter. A “high-pass” filter, as referred to herein, is a filter that passes signals with a frequency higher than a cutoff frequency and attenuates (weakens) signals with frequencies lower than the cutoff frequency. A “low-pass” filter, as referred to herein, is a filter that passes signals with a frequency less than a cutoff frequency and attenuates signals with frequencies greater than the cutoff frequency. An amount of attenuation for each frequency depends on filter parameters such as the cutoff frequency, filter gain, etc.

A “cutoff” frequency is a threshold in a filter frequency response at which, in a high-pass filter, energy flowing through the filter begins to be attenuated (weakened) rather than being passed through, or, in a low-pass filter, begins to pass though rather than being attenuated. Typically, a power level for the cutoff frequency is at a threshold of 3 db (decibel), i.e., where signal power drops to half of its mid band power.

The computer 110 may be programed to perform filter operations such as applying the high-pass and/or the low-pass filter to the steering torque, steering wheel 155 angle, etc. The computer 110 is typically programmed based on digital signal processing techniques. Filters are typically specified as continuous-time operations, whereas the computer 110 is typically programmed to execute discrete-time operations. Thus, various techniques such as Tustin transformation may be used to transform the filter operation from a continuous-time operation to a discrete-time operation. The computer 110 can be then programmed based on the transformed discrete-time filter operation.

As discussed above, the filter parameters may be based on the vehicle 100 speed. For example, the computer 110 may be programmed to determine the cutoff frequency of the high-pass filter based on vehicle 100 speed. In other words, the frequency response of the high-pass filter may change based on changes of the vehicle 100 speed. In one example, the computer 110 may be programmed to determine the cutoff frequency of the high-pass filter by selecting, based on the vehicle 100 speed, the cutoff frequency from multiple predetermined cutoff frequencies. For example, Table 1 shows various cutoff frequencies and vehicle 100 speed ranges associated with each of the cutoff frequencies. The computer 110 may be programmed to select the cutoff frequency of the high-pass and/or the low-pass filter based on the vehicle 100 speed as shown in Table 1. In another example, the cutoff frequency may increase as the vehicle 100 speed increases, e.g., based on a linear relationship between the vehicle 100 speed and the cutoff frequency. Additionally or alternatively, the computer 110 may be programmed to adjust any other filter parameter such as filter gain based on the vehicle 100 speed.

TABLE 1

| Cutoff frequency (Hz) | Vehicle speed range (Km/h) |
|---|---|
| 5 Hz | Below 20 |
| 15 Hz | 20 to 40 |
| 30 Hz | Greater than 40 |

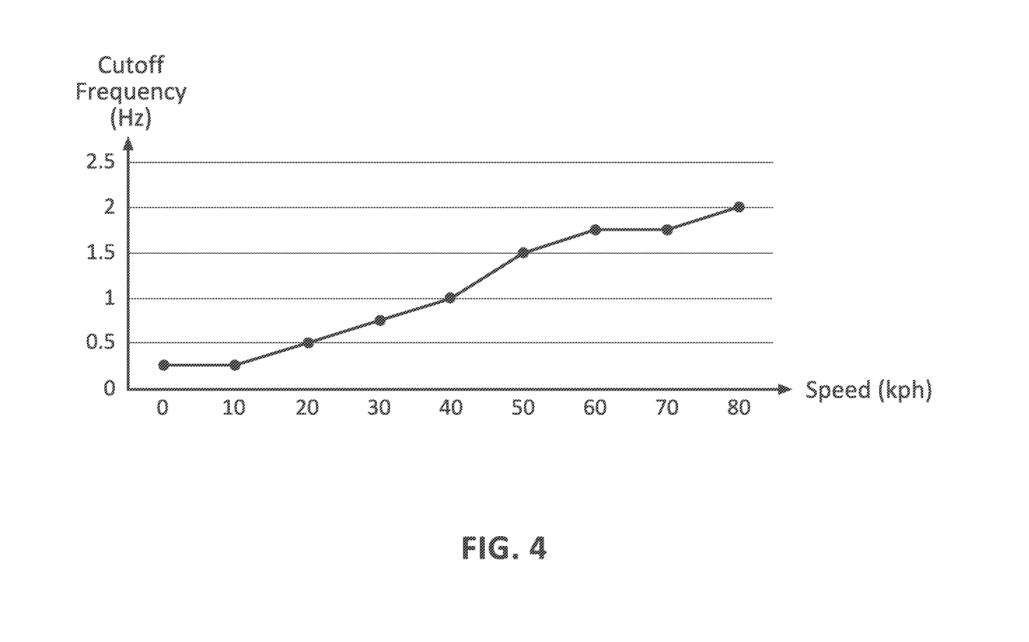

In another example, the computer 110 may be programmed to determine a parameter of the filter such as the cutoff frequency, gain, etc. based on the vehicle 100 speed i.e., according to a function that relates the filter parameter to the vehicle 100 speed. The function may specify a linear and/or non-linear relationship between the vehicle 100 speed and the filter parameter, e.g., the filter cutoff frequency. As shown in an exemplary graph in FIG. 4, a filter cutoff frequency may increase, e.g., non-linearly, as the vehicle 100 speed increases.

As shown in FIG. 3, the computer 110 may be programmed to determine a torsion bar 175 differential angle based on the input steering torque, and determine a steering wheel 155 angle based on the torsion bar 175 differential angle and the vehicle 100 steering pinion 170 angle. For example, the computer 110 may be programmed to determine the differential angle by multiplying the received steering torque and a parameter K2. The parameter K2 may be defined and/or adjusted based at least in part on physical properties of the torsion bar 175 such as stiffness. An amount of the differential angle may be related to the stiffness of the torsion bar 175.

The computer 110 may be programmed to determine a filtered steering wheel 155 acceleration by applying the high-pass filter on the determined steering wheel 155 angle. The high-pass filter may include a second derivative operation. Thus, the high-pass filter may output a filtered rotational acceleration of the steering wheel 155. In other words, a rotational speed of the steering wheel 155 may be determined based on a first derivative of the steering wheel 155 angle, and the rotational acceleration of the steering wheel 155 may be determined based on a first derivative of the rotational speed of the steering wheel 155, i.e., as a second derivative of the angle, i.e., a change in position of the steering wheel 155 over time.

The computer 110 may be programmed to determine a torque offset based on a steering system 150 inertia K3 and an output of the high-pass filter (i.e., the filtered steering wheel 155 acceleration). The inertia K3 of the steering system 150 may be determined based on a mass of steering system 150 components, e.g., the steering wheel 155, steering column 180, etc. As discussed above, the output of the high-pass filter may be a filtered steering wheel 155 acceleration. Thus, the computer 110 may be programmed to determine the torque offset based on the outputted filtered steering wheel 155 acceleration and the inertia K3, e.g., by multiplying inertia K3 by the filtered steering wheel 155 acceleration. The computer 110 may be programmed to determine the compensated steering torque based on the received steering torque and the determined torque offset.

Additionally, the computer 110 may be programmed to determine a filtered compensated steering torque by applying a low-pass filter to the determined compensated steering torque and actuate a vehicle 100 component based at least in part on the determined filtered compensated steering torque. For example, the low-pass filter may have a cutoff frequency of 3 Hz. The computer 110 may actuate a mode of operation of the vehicle 100 such as non-autonomous mode based on the filtered compensated steering torque and the torque threshold. Thus, advantageously, the low-pass filter may prevent that the compensated steering torque unexpectedly exceeds the torque threshold and as a result of that causing a change of the vehicle 100 mode of operation.

### Processing

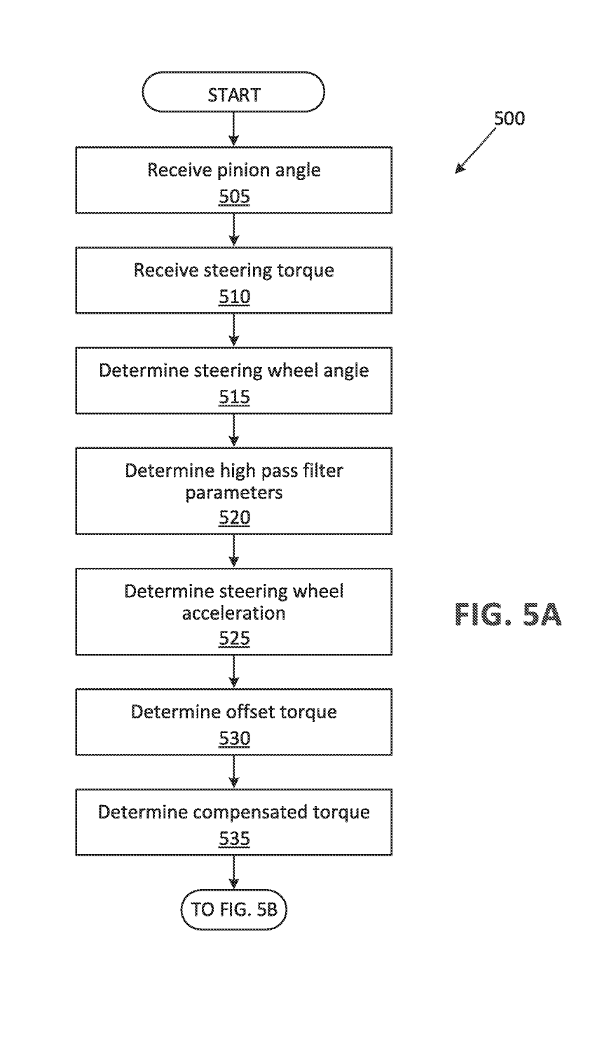

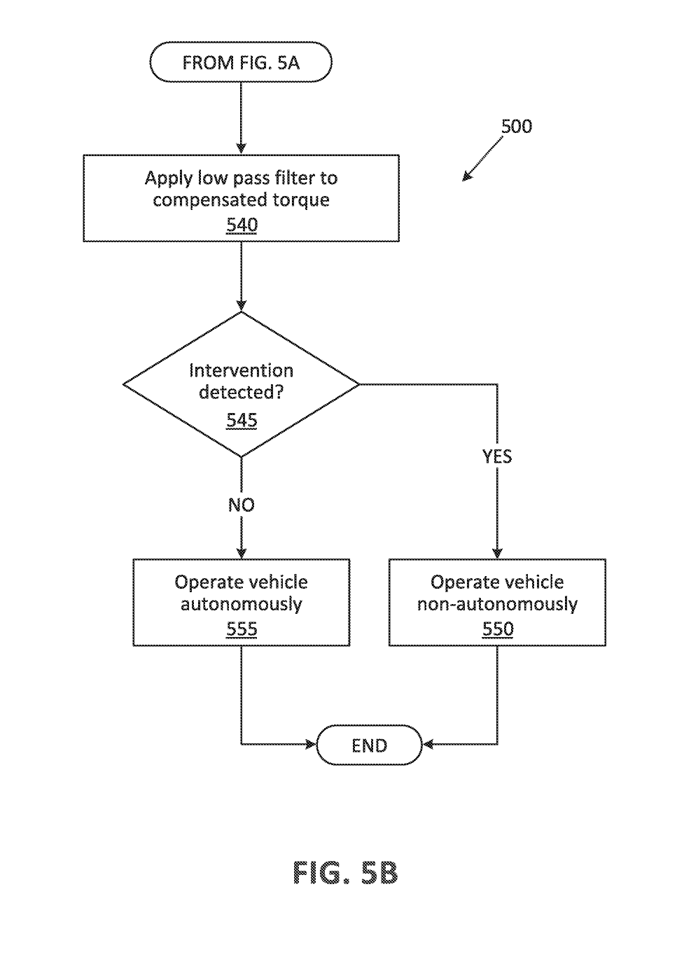

FIGS. 5A-5B are a flowchart of an exemplary process 500 for controlling vehicle 100 operation. For example, the vehicle 100 computer 110 may be programmed to execute blocks of the process 500.

Referring to FIG. 5A, the process 500 begins in a block 505, in which the computer 110 receives the pinion 170 angle. For example, the computer 110 may be programmed to receive the pinion 170 angle from a sensor 130A coupled to the pinion 170, via a vehicle 100 communication network.

Next, in a block 510, the computer 110 receives the steering torque (as defined above). For example, the computer 110 may be programmed to receive the steering torque, via the vehicle 100 communication network, from the torque sensor 130B coupled to the torsion bar 175.

Next, in a block 515, the computer 110 determines the steering wheel 155 angle. For example, the computer 110 determines the differential angle of the torsion bar 175 based on the received steering torque, and determine the steering wheel angle 155 based on the determined differential angle of the torsion bar 175 and the received pinion 155 angle.

Next, in a block 520, the computer 110 determines high-pass filter parameter(s) based at least in part on the vehicle 100 speed. For example, the computer 110 may be programmed to select a cutoff frequency of the high-pass filter from multiple predetermined cutoff frequencies. As another example, the computer 110 may be programmed to determine a filter parameter based on a predetermined graph of the filter parameter versus the vehicle 100 speed.

Next, in a block 525, the computer 110 determines the steering wheel 155 acceleration. For example, the computer 110 may be programmed to determine the steering wheel 155 acceleration based on the determined steering wheel 155 angle using a 2^{nd} derivative operation included in the high-pass filter operation.

Next, in a block 530, the computer 110 determines an offset torque. The computer 110 may be programmed to determine the offset torque of the steering wheel 155 based on the steering system 150 inertia, the determined filtered steering wheel 155 acceleration, and the received steering wheel 155 torque.

Next, in a block 535, the computer 110 determines the compensated steering torque. For example, the computer 110 may be programmed to determine the compensated steering torque based on the torque offset and the received steering torque.

Turning to FIG. 5B, next, in a block 540, the computer 110 applies a low-pass filter to the compensated steering torque. For example, the computer 110 may be programmed to apply a low-pass filter to the compensated steering torque and output a filtered compensated steering torque. Additionally or alternatively, a low-pass filter may be applied to the received steering torque prior to determination of the torque offset.

Next, in a decision block 545, the computer 110 determines whether a user steering intervention was detected. For example, the computer 110 may be programmed to determine that a vehicle 100 user intervention was detected upon determining that the filtered compensated steering torque or compensated steering torque exceeds the predetermined torque threshold. If the computer 110 determines that a user intervention has occurred, then the process 500 proceeds to a block 550; otherwise the process 500 proceeds to a block 555.

In the block 550, the computer 110 operates the vehicle in the non-autonomous mode. Alternatively, the computer 110 may be programmed to actuate the vehicle 100 to operate in the semi-autonomous mode. For example, the computer 110 may be programmed to deactivate an autonomous steering operation whereas the computer 110 actuates the vehicle 100 acceleration and braking in an autonomous mode.

In the block 555, the computer 110 the computer 110 operates the vehicle 100 in the autonomous mode. For example, the computer 110 may be programmed to actuate the vehicle 100 steering, acceleration, and braking in the autonomous mode.

Following the blocks 550 and 555, the process 500 ends, or alternatively returns to the block 505, although not shown in FIGS. 5A-5B.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH, an EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer programmed to:
determine a vehicle steering wheel angle based on a vehicle steering torque and a vehicle pinion angle;
determine a compensated steering torque by applying a high-pass filter to the determined vehicle steering wheel angle, wherein a parameter of the high-pass filter is based on a vehicle speed; and
actuate a vehicle component based on the determined compensated steering torque.

2. The system of claim 1, wherein the computer is further programmed to determine the compensated steering torque based on the input torque.

3. The system of claim 1, wherein the computer is further programmed to receive the vehicle steering pinion angle from a pinion angle sensor that is engaged to a lower end of the vehicle pinion.

4. The system of claim 1, further comprising the vehicle pinion including a lower end of the vehicle pinion that is mechanically coupled to a vehicle steering rack and an upper end of the vehicle pinion that is mechanically coupled, via a torsion bar, to the vehicle steering wheel.

5. The system of claim 1, wherein the computer is further programmed to determine a cutoff frequency of the high-pass filter based on vehicle speed.

6. The system of claim 5, wherein the computer is further programmed to determine the cutoff frequency of the high-pass filter by selecting, based on the vehicle speed, the cutoff frequency from a plurality of predetermined cutoff frequencies.

7. The system of claim 1, wherein the computer is further programmed to select a mode of operation based on the determined compensated steering torque and a predetermined torque threshold and actuate the vehicle component based on the selected vehicle mode of operation.

8. The system of claim 7, wherein the selected mode of operation is one of a vehicle autonomous mode and a vehicle non-autonomous mode of operation.

9. The system of claim 7, wherein the computer is further programmed to actuate a non-autonomous mode of operation upon determining that the compensated steering torque exceeds the predetermined torque threshold.

10. The system of claim 1, wherein the computer is further programmed to:
determine a filtered compensated steering torque by applying a low-pass filter to the determined compensated steering torque; and
actuate the vehicle component based at least in part on the determined filtered compensated steering torque.

11. The system of claim 1, wherein the computer is further programmed to determine a torque offset based on a steering wheel inertia and an output of the high-pass filter.

12. The system of claim 1, wherein the computer is further programmed to receive the input torque from a torque sensor coupled to a lower end of a torsion bar.

13. The system of claim 1, wherein the computer is further programmed to:
determine a torsion bar differential angle based on the input torque; and
determine a steering wheel angle based on the torsion bar differential angle and the vehicle steering pinion angle.

14. A method, comprising:
determining a vehicle steering wheel angle based on a vehicle steering torque and a vehicle pinion angle;
determining a compensated steering torque by applying a high-pass filter to the determined vehicle steering wheel angle, wherein a parameter of the high-pass filter is based on a vehicle speed; and
actuating a vehicle component based on the determined compensated steering torque.

15. The method of claim 14, further comprising determining the compensated steering torque based on the input torque.

16. The method of claim 14, further comprising receiving the vehicle steering pinion angle from a pinion angle sensor that is engaged to a lower end of the vehicle pinion.

17. The method of claim 14, further comprising actuating a non-autonomous mode of vehicle operation upon determining that the compensated steering torque exceeds the predetermined torque threshold.

18. The method of claim 14, further comprising:
determining a filtered compensated steering torque by applying a low-pass filter to the determined compensated steering torque; and
actuating the vehicle component based at least in part on the determined filtered compensated steering torque.

19. The method of claim 14, further comprising determining a torque offset based on a steering wheel inertia and an output of the high-pass filter.

20. The method of claim 14, further comprising:
determining a torsion bar differential angle based on the input torque; and
determining a steering wheel angle based on the torsion bar differential angle and the vehicle steering pinion angle.
